(19) United States
(12) Patent Application Publication
(10) Pub. No.: US 2023/0150061 A1
(43) Pub. Date: May 18, 2023

(54) LASER PROCESSING APPARATUS

(71) Applicant: MITSUBISHI HEAVY INDUSTRIES, LTD., Tokyo (JP)

(72) Inventor: Saneyuki Goya, Tokyo (JP)

(73) Assignee: MITSUBISHI HEAVY INDUSTRIES, LTD., Tokyo (JP)

(21) Appl. No.: 17/916,232

(22) PCT Filed: Mar. 2, 2021
(86) PCT No.: PCT/JP2021/007920

§ 371 Date: Sep. 30, 2022

(30) Foreign Application Priority Data
Apr. 8, 2020 (JP) 2020-069770

(51) Int. Cl. B23K 26/066; B23K 26/082; B23K 26/70

(52) U.S. Cl. CPC B23K 26/066; B23K 26/082; B23K 26/703

(57) ABSTRACT

A laser processing apparatus includes: an electro-optical element; a laser irradiation unit that irradiates the electro-optical element with laser; a pair of electrodes provided on both sides of the electro-optical element so as to sandwich the electro-optical element therebetween; a cushioning material having conductivity provided between the pair of electrodes and the electro-optical element; a shield material that is provided on an incident side of the electro-optical element, in an irradiation direction of the laser intersecting a direction in which a voltage applied by the pair of electrodes is applied, and prevents incidence of the laser onto the cushioning material; and a cooling unit that cools the shield material. The cooling unit includes a cooling block and a pipe connected to the cooling block.

### TECHNICAL FIELD

The present disclosure relates to a laser processing apparatus.

### BACKGROUND ART

In the related art, an electro-optical element such as a KTN crystal, in which an upper and lower surfaces are sandwiched and held by two metal blocks via a graphite sheet, is known. Since the deflection characteristics of this electro-optical element strongly depend on the temperature, a Peltier device is disposed inside two metal blocks in order to prevent the temperature rise when a voltage is applied, and the temperature of the electro-optical element is controlled to be constant with high precision.

### Citation List

### Patent Literature

[PTL 1] Japanese Unexamined Patent Application Publication No. 2017-203847.

### SUMMARY OF INVENTION

### Technical Problem

Incidentally, in a laser processing apparatus that performs processing using laser, the optical deflector of Patent Document 1 may be used to deflect the laser. In this case, a graphite sheet is irradiated with some of the laser (the beam profile bottom) applied to the electro-optical element of the optical deflector, and the graphite sheet is melted, so that a part of the graphite sheet may adhere to the electro-optical element. When the graphite sheet adheres to the electro-optical element, the laser is absorbed by the graphite sheet adhering to the surface of the electro-optical element, which may cause the temperature of the electro-optical element to rise. Further, when the metal electrodes on the upper and lower parts of the electro-optical element are irradiated with the laser, the temperature rise of the irradiated portion causes the temperature rise of the KTN crystal. The change in the temperature of the electro-optical element changes the characteristics of light deflection and reduces the accuracy of the laser irradiation position on the point to be processed.

Therefore, an object of the present disclosure is to provide a laser processing apparatus capable of preventing a temperature rise of an electro-optical element, stabilizing the temperature of the electro-optical element, and controlling laser deflection with high accuracy.

### Solution to Problem

A laser processing apparatus of the present disclosure includes: an electro-optical element; a laser irradiation unit that irradiates the electro-optical element with laser; a pair of electrodes provided on both sides of the electro-optical element so as to sandwich the electro-optical element therebetween; a cushioning material having conductivity provided between the pair of electrodes and the electro-optical element; and a shield material that is provided on an incident side of the electro-optical element, in an irradiation direction of the laser, intersecting a direction in which an electric field applied by the pair of electrodes is applied, and prevents incidence of the laser onto the cushioning material.

Another laser processing apparatus of the present disclosure includes: an electro-optical element; a laser irradiation unit that irradiates the electro-optical element with laser; a pair of electrodes provided on both sides of the electro-optical element so as to sandwich the electro-optical element therebetween; a cushioning material having conductivity provided between the pair of electrodes and the electro-optical element; and a window material that is provided on an incident side of the electro-optical element, in an irradiation direction of the laser, intersecting a direction in which an electric field applied by the pair of electrodes is applied, and covers the electro-optical element.

### Advantageous Effects of Invention

According to the present disclosure, it is possible to prevent the temperature rise of the electro-optical element, stabilize the temperature of the electro-optical element, and control the laser irradiation position with high accuracy.

### BRIEF DESCRIPTION OF DRAWINGS

FIG. 1 is a diagram schematically showing a laser processing apparatus according to Embodiment 1.

FIG. 2 is a two-sided view schematically showing an optical deflector.

FIG. 3 is an explanatory diagram relating to the dimensions of an optical deflector.

FIG. 4 is a diagram schematically showing an optical deflector of a laser processing apparatus according to Embodiment 2.

FIG. 5 is a two-sided view schematically showing an optical deflector of a laser processing apparatus according to Embodiment 3.

FIG. 6 is a diagram schematically showing an optical deflector of a laser processing apparatus according to Embodiment 4.

FIG. 7 is a two-sided view schematically showing an optical deflector of a laser processing apparatus according to Embodiment 5.

### DESCRIPTION OF EMBODIMENTS

Hereinafter, embodiments according to the present disclosure will be described in detail with reference to the drawings. In addition, the present invention is not limited to these embodiments. In addition, the components in the following embodiments include those that can be easily replaced by those skilled in the art, or those that are substantially the same. Further, the components described below can be appropriately combined, and when there are a plurality of embodiments, each embodiment can be combined.

### Embodiment 1

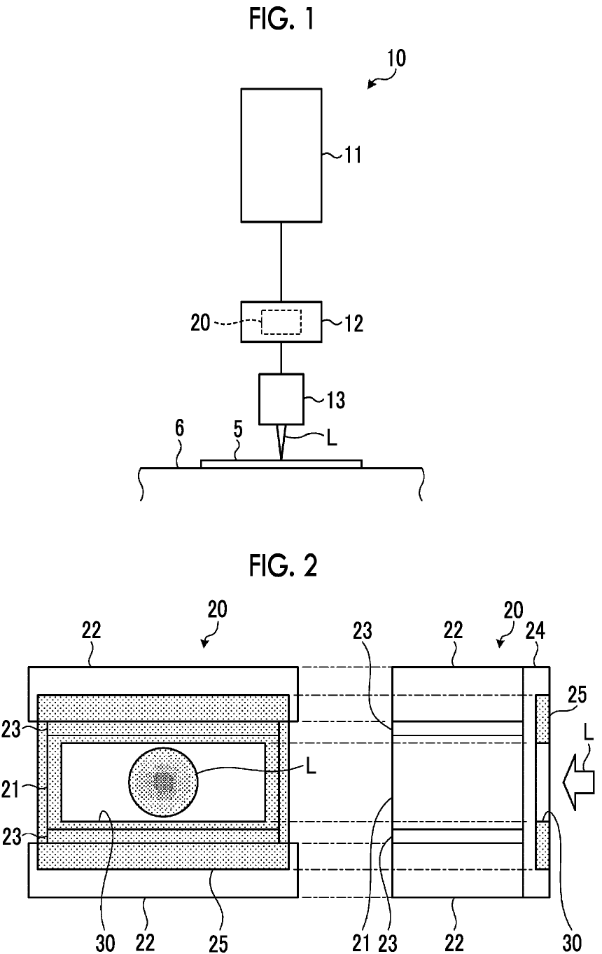

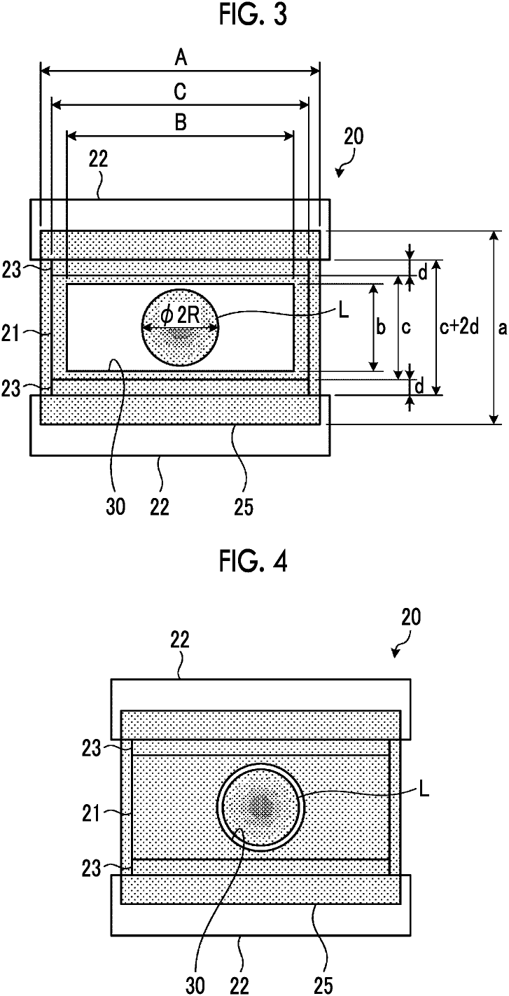

FIG. 1 is a diagram schematically showing a laser processing apparatus according to Embodiment 1. FIG. 2 is a two-sided view schematically showing a KTN crystal and the circumference thereof. FIG. 3 is an explanatory diagram relating to the dimensions of the KTN crystal and the circumference thereof. As shown in FIG. 1, the laser processing apparatus 10 according to Embodiment 1 is an apparatus capable of irradiating a work piece 5 with the laser L to process the work piece 5.

As shown in FIG. 1, the laser processing apparatus 10 includes a laser irradiation device 11, a scanning optical system 12, a focus optical system 13, and a support table 6.

The laser irradiation device 11 is a device that outputs laser L. The laser irradiation device 11 may use a pulse wave or a continuous wave, as the laser L to be output. Further, the laser irradiation device 11 may emit the laser L in a single mode or a multi-mode. Since the KTN crystal contains a plurality of elements (Ka, Ta, Nb) and it is difficult to increase the size, the laser irradiation device 11 includes a reduction optical system that reduces the beam diameter and converts the beam into parallel light such that the KTN crystal can be irradiated with laser light.

The laser L emitted from the laser irradiation device 11 is a processing laser, and is a high-power laser having an output of 1 W or more. Specifically, the frequency of the laser L is about 1 kHz to 1000 kHz, and the output of the laser L is about 10 W to 10 kW. The wavelength of the laser L is not particularly limited, but may be a wavelength band suitable for the KTN crystal that is the electro-optical element 21 provided in the scanning optical system 12 described later.

The scanning optical system 12 is an optical system that scans the laser L emitted from the laser irradiation device 11 on the work piece 5. The scanning optical system 12 includes a scanner 20 capable of operating laser within the surface of the work piece 5. The scanner 20 is an optical deflector using the electro-optical element 21.

The focus optical system 13 is an optical system that condenses the laser L emitted from the scanning optical system 12 at a focal point and applies the condensed laser L on the work piece 5. The focus optical system 13 includes an optical member such as a condensing lens.

The support table 6 supports the work piece 5 at a predetermined position. The support table 6 may be a moving stage for moving the work piece 5 in the horizontal plane. The laser L emitted from the laser irradiation device 11 irradiates the surface of the work piece 5 disposed on the support table 6.

The laser processing apparatus 10 configured as described above emits the laser L from the laser irradiation device 11, and guides the emitted laser L to the scanning optical system 12. The laser processing apparatus 10 scans the scanning optical system 12 with the incident laser L to change the irradiation position of the laser L on the surface of the work piece 5. The laser processing apparatus 10 inputs the laser L emitted from the scanning optical system 12 to the focus optical system 13, and applies the condensed laser L on the work piece 5.

Next, the scanner 20 will be described with reference to FIGS. 2 and 3. As shown in FIGS. 2 and 3, the scanner 20 includes an electro-optical element 21, a pair of electrodes 22, a cushioning material 23, an insulation material (insulating portion) 24, and a shield material 25. Inside the electrode 22, a temperature control element such as a Peltier device is included in order to control the temperature with high accuracy. The scanner 20 controls the electron density in the electro-optical element 21 by applying a voltage to the electro-optical element 21 by the pair of electrodes 22 in the direction facing each other, thereby changing the refractive index and deflecting the laser L in the application direction of the voltage. The laser L incident on the scanner 20 is broad laser emitted from a laser oscillator, or collimated laser whose beam diameter is controlled by a reduction optical system required to enter collimated light into an electro-optical element.

A KTN crystal is used for the electro-optical element 21, and the electro-optical element 21 is provided on the optical path of the laser L. The size of the KTN crystal is small, for example, the plate thickness of the irradiation surface on which the laser is incident is about 1 to 2 mm. The electro-optical element 21 is irradiated with the laser L.

For example, a copper electrode is applied to the pair of electrodes 22. The pair of electrodes 22 are provided on both sides of the electro-optical element 21 so as to sandwich the electro-optical element therebetween. A voltage is applied to the pair of electrodes 22 in the directions facing each other. The irradiation direction of the laser and the application direction of the voltage are orthogonal to each other.

The cushioning materials 23 are provided between the electro-optical element 21 and the pair of electrodes 22, respectively. The cushioning material 23 has conductivity. The cushioning material 23 is, for example, a carbon film.

The insulation material 24 is provided on the incident side of the electro-optical element 21 in the irradiation direction of the laser L. Further, the insulation material 24 is provided between the shield material 25 and the electrode 22, which will be described later, and insulates the shield material 25 and the electrode 22. The insulation material 24 also functions as a support member for supporting the shield material 25.

The shield material 25 is provided on the incident side of the insulation material 24 in the irradiation direction of the laser L. Further, the shield material 25 shields the laser L from entering the cushioning material 23. The shield material 25 is formed in a plate shape and has an opening 30 through which the laser L passes. The opening 30 is formed in the central portion of the shield material 25 and is a rectangular opening. Therefore, the shield material 25 is formed in a four-sided frame shape. The shield material 25 is made of metal, and the shield material 25 is not particularly limited to metal, and ceramic may be applied, for example. Further, the shield material 25 prevents the incidence of the laser L onto at least the cushioning material 23, and specifically, covers a part of the electrodes 22 and the cushioning material 23 so as to prevent incidence of the laser L thereto.

Next, the dimensions of the shield material 25 will be described with reference to FIG. 3. In the orthogonal plane orthogonal to the irradiation direction of the laser L, the direction in which the pair of electrodes 22 face each other is the height direction, and the direction orthogonal to the height direction is the width direction. Here, the length of the shield material 25 in the width direction is A, the length of the opening 30 of the shield material 25 in the width direction is B, and the length of the electro-optical element 21 in the width direction is C. Further, the length of the shield material 25 in the height direction is a, the length of the opening 30 of the shield material 25 in the height direction is b, and the length of the electro-optical element 21 in the height direction is c. Further, the thickness of the cushioning material 23 in the height direction is d. Further, the beam diameter φ of the laser L is 2R.

In the width direction, the length A of the shield material 25 is equal to or greater than the length C of the electro-optical element 21. The length B of the opening 30 of the shield material 25 is larger than the beam diameter φ2R of the laser L, and is equal to or less than the length C of the electro-optical element 21.

In the height direction, the length a of the shield material 25 is equal to or greater than the total length (c + 2d) of the electro-optical element 21 and the cushioning materials 23 on both sides. Further, the length a of the shield material 25 is preferably twice or more the beam diameter φ2R of the laser L. The length b of the opening 30 of the shield material 25 is larger than the beam diameter φ2R of the laser L and is smaller than the length c of the electro-optical element 21. In the shield material 25, the length ((c - b)/2) between the opening 30 of the shield material 25 and the cushioning material 23 is 0.1 mm or more or 10% or more of the beam diameter φ2R, whichever is smaller.

When the laser L is incident on the scanner 20 as described above, the laser L is incident on the electro-optical element 21 through the opening 30 of the shield material 25. At this time, the laser L is prevented from being incident on the cushioning material 23 by the shield material 25.

In Embodiment 1, the shield material 25 has an opening 30 formed therein, but the configuration is not particularly limited as long as the cushioning material 23 can be covered. For example, the shield material 25 has a divided structure, and may be configured to cover the cushioning materials 23 on both sides of the electro-optical element 21, respectively.

Further, in Embodiment 1, the insulation material 24 is provided between the shield material 25 and the electrode 22, but the configuration is not particularly limited. Since the insulating state between the shield material 25 and the electrode 22 needs to be maintained, air may be applied as an insulating portion between the shield material 25 and the electrode 22.

### Embodiment 2

Next, the laser processing apparatus 10 according to Embodiment 2 will be described with reference to FIG. 4. In addition, in Embodiment 2, in order to avoid duplicate description, the parts different from Embodiment 1 will be described, and the parts having the same configuration as Embodiment 1 will be described with the same reference numerals. FIG. 4 is a diagram schematically showing an optical deflector of the laser processing apparatus according to Embodiment 2.

In the laser processing apparatus 10 of Embodiment 2, the shape of the opening 30 of the shield material 25 of the scanner 20 is circular instead of rectangular. Even when the opening 30 has a circular shape, the dimensions of the opening 30 shown in Embodiment 1 are satisfied. In the laser processing apparatus 10 of Embodiment 2, by making the opening 30 circular, it is possible to apply the laser L aiming at the center of the opening 30.

### Embodiment 3

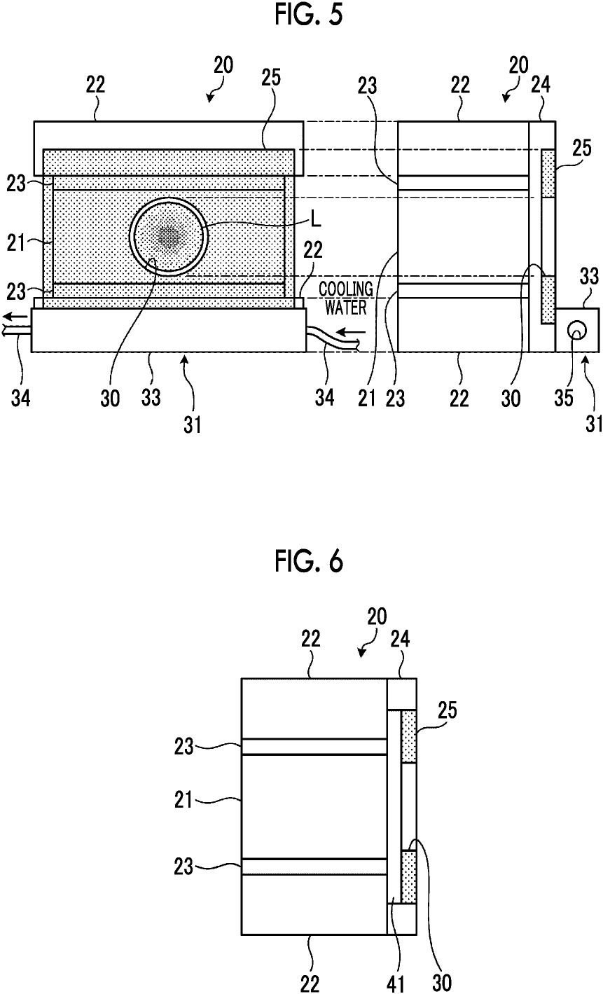

Next, the laser processing apparatus 10 according to Embodiment 3 will be described with reference to FIG. 5. In addition, even in Embodiment 3, in order to avoid duplicate description, the parts different from Embodiments 1 and 2 will be described, and the parts having the same configuration as those of Embodiments 1 and 2 will be described with the same reference numerals. FIG. 5 is a two-sided view schematically showing the optical deflector of the laser processing apparatus according to Embodiment 3.

The laser processing apparatus 10 of Embodiment 3 further includes a cooling unit 31 in addition to the scanner 20 of Embodiment 2. The cooling unit 31 cools the shield material 25 and also cools the electro-optical element 21 via the shield material 25. The cooling unit 31 includes a cooling block 33 and a pipe 34 connected to the cooling block 33. The cooling block 33 is provided at a portion located on one electrode 22 side of the shield material 25, and is provided so as to extend in the width direction. The cooling block 33 is formed of metal, and a flow path 35 through which cooling water flows is formed inside the cooling block 33. The pipe 34 is connected to the flow path 35 of the cooling block 33 to circulate the cooling water. Therefore, the cooling unit 31 cools the shield material 25 by circulating cooling water through the pipe 34 to the cooling block 33, and also cools the electro-optical element 21 via the shield material 25.

In Embodiment 3, the cooling unit 31 is provided on the shield material 25, but the cooling unit 31 and the shield material 25 may be integrated. That is, the cooling water flow path through which the cooling water flows may be formed in the shield material 25, and the cooling water may flow through the cooling water flow path. Further, in Embodiment 3, the cooling unit 31 has a water-cooled structure using cooling water, but may have an air-cooled structure. For example, the cooling unit 31 includes fins provided on the shield material 25 and an air cooling fan that sends cooling air toward the fins. The cooling unit 31 cools the shield material 25 by sending cooling air toward the fins by an air cooling fan.

### Embodiment 4

Next, the laser processing apparatus 10 according to Embodiment 4 will be described with reference to FIG. 6. In addition, even in Embodiment 4, in order to avoid duplicate description, the parts different from Embodiments 1 to 3 will be described, and the parts having the same configuration as those of Embodiments 1 to 3 will be described with the same reference numerals. FIG. 6 is a diagram schematically showing an optical deflector of the laser processing apparatus according to Embodiment 4.

The laser processing apparatus 10 of Embodiment 4 further includes a window material 41 in addition to the scanner 20 of Embodiments 1 and 2. The window material 41 of Embodiment 4 may be applied to Embodiment 3.

The window material 41 is provided on the incident side of the electro-optical element 21 in the irradiation direction of the laser L, and covers the electro-optical element 21. Further, the window material 41 is provided between the electro-optical element 21 and the shield material 25. The window material 41 is glass such as quartz. The window material 41 is formed in a plate shape and also functions as an insulation material. The window material 41 prevents the adhesion of dust to the electro-optical element 21.

### Embodiment 5

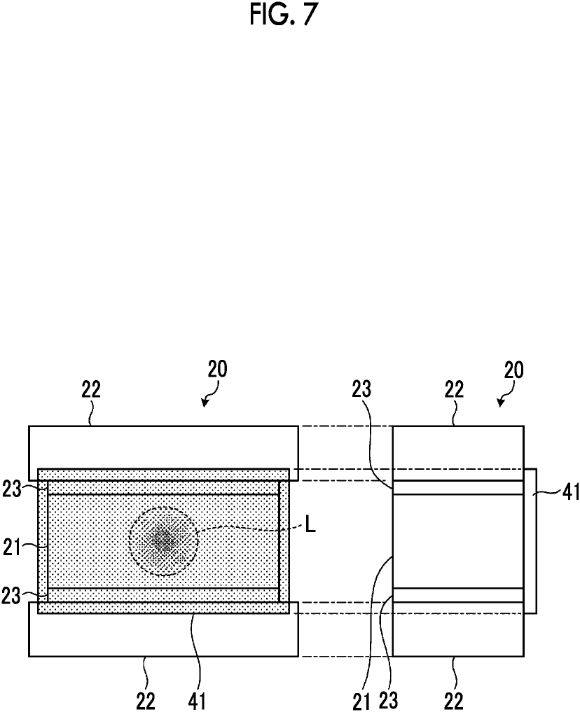

Next, a laser processing apparatus 10 according to Embodiment 5 will be described with reference to FIG. 7. In addition, even in Embodiment 5, in order to avoid duplicate description, the parts different from Embodiments 1 to 4 will be described, and the parts having the same configuration as those of Embodiments 1 to 4 will be described with the same reference numerals. FIG. 7 is a two-sided view schematically showing the optical deflector of the laser processing apparatus according to Embodiment 5.

The laser processing apparatus 10 of Embodiment 5 is obtained by omitting the shield material 25 and the insulation material 24 from the scanner 20 of Embodiment 4. That is, the scanner 20 of Embodiment 5 includes an electro-optical element 21, a pair of electrodes 22, a cushioning material 23, and a window material 41. The window material 41 is provided on the incident side of the electro-optical element 21 in the irradiation direction of the laser L, and covers the electro-optical element 21. The window material 41 prevents the adhesion of dust to the electro-optical element 21.

As described above, the laser processing apparatus 10 described in the present embodiment is understood as follows, for example.

The laser processing apparatus 10 according to the first aspect includes an electro-optical element 21, a laser irradiation unit (laser irradiation device 11) that irradiates the electro-optical element 21 with laser L, a pair of electrodes 22 provided on both sides of the electro-optical element 21 so as to sandwich the electro-optical element 21 therebetween, a cushioning material 23 having conductivity provided between the pair of electrodes 22 and the electro-optical element 21, and a shield material 25 that is provided on an incident side of the electro-optical element 21, in an irradiation direction of the laser L, intersecting a direction in which a voltage applied by the pair of electrodes 22 is applied, and prevents incidence of the laser L onto the cushioning material 23.

According to this configuration, the shield material 25 can prevent the laser L from being incident on the cushioning material 23. Therefore, it is possible to prevent the cushioning material 23 from being irradiated with a part of the laser L, which prevents the cushioning material 23 from being melted and evaporated by the irradiation of a part of the laser L and adhering to the electro-optical element 21, so that the temperature rise caused by the cushioning material 23 adhering to the electro-optical element 21 absorbing the laser light can be prevented, the temperature of the electro-optical element 21 can be stabilized, and the irradiation position of the laser can be controlled with high accuracy.

In a second aspect, the electro-optical element 21 is a KTN crystal.

According to this configuration, it is possible to stabilize the temperature of the KTN crystal whose light deflection characteristics are likely to change depending on the temperature.

In a third aspect, the shield material 25 is formed in a plate shape and has an opening 30 through which the laser L passes.

According to this configuration, by forming the opening 30, it is possible to handle the shield material 25 as a unit, while allowing the laser L to enter the electro-optical element 21.

In a fourth aspect, in an orthogonal plane orthogonal to the irradiation direction of the laser, a direction in which the pair of electrodes 22 face each other is a height direction, and a direction orthogonal to the height direction is a width direction, and in the shield material 25, the length of the opening 30 in the height direction is larger than the beam diameter φ of the laser L, and smaller than the length of the electro-optical element 21 in the height direction, and a length between the opening 30 and the cushioning material 23 is 0.1 mm or more or 10% or more of the beam diameter, whichever is smaller.

According to this configuration, the laser L can be appropriately incident on the electro-optical element 21 while appropriately covering the cushioning material 23.

In a fifth aspect, a length of the opening 30 in the width direction is larger than the beam diameter φ of the laser L and is equal to or less than a length of the electro-optical element 21 in the width direction.

According to this configuration, the laser L can be appropriately incident on the electro-optical element 21 without leaking the laser L from the electro-optical element 21.

In a sixth aspect, the shield material is made of metal, and further includes an insulating portion provided between the shield material and the electrode.

According to this configuration, the electrical connection between the shield material 25 and the electrode 22 can be prevented.

In a seventh aspect, the laser L incident on the electro-optical element 21 is collimated laser.

According to this configuration, since the collimated laser L can be incident on the electro-optical element 21, the laser L can be suitably deflected by the electro-optical element 21.

In an eighth aspect, a cooling unit 31 that cools the shield material 25 is further provided.

According to this configuration, the shield material 25 can be cooled by the cooling unit 31, and the electro-optical element 21 can be cooled via the shield material 25.

In a ninth aspect, a window material 41 that is provided on the incident side of the electro-optical element 21 in the irradiation direction of the laser L and covers the electro-optical element 21 is further provided.

According to this configuration, the window material 41 can prevent the adhesion of dust to the electro-optical element 21. Therefore, it is possible to prevent the temperature rise of the electro-optical element 21 due to the irradiation of the dust with the laser L.

In a tenth aspect, the window material 41 is provided between the electro-optical element 21 and the shield material 25.

According to this configuration, since the window material 41 can be disposed closer to the electro-optical element 21 than the shield material 25, it is possible to suitably prevent dust from adhering to the electro-optical element 21.

In an eleventh aspect, the shield material 25 is made of metal, and the window material 41 functions as an insulation material 24 provided between the shield material 25 and the electrode 22.

According to this configuration, the window material 41 can also function as the insulation material 24 that insulates the conductivity between the electrode 22 and the shield material 25, so that it is not necessary to provide the window material 41 and the insulation material 24, respectively, and the configuration can be simplified.

The laser processing apparatus 10 according to the twelfth aspect includes an electro-optical element 21, a laser irradiation unit (laser irradiation device 11) that irradiates the electro-optical element 21 with laser L, a pair of electrodes 22 provided on both sides of the electro-optical element 21 so as to sandwich the electro-optical element 21 therebetween, a cushioning material 23 having conductivity provided between the pair of electrodes 22 and the electro-optical element 21, and a window material 41 that is provided on an incident side of the electro-optical element 21, in an irradiation direction of the laser L, intersecting a direction in which a voltage applied by the pair of electrodes 22 is applied, and covers the electro-optical element 21.

According to this configuration, the window material 41 can prevent the adhesion of dust to the electro-optical element 21. Therefore, it is possible to prevent the temperature rise of the electro-optical element 21 due to the irradiation of the dust with the laser L, and to stabilize the temperature of the electro-optical element 21.

### Reference Signs List

5 Work piece
6 Suport table
10 Laser processing apparatus
11 Laser irradiation device
12 Scanning optical system
13 Focus optical system
20 Scanner
21 Electro-optical element
22 Electrode
23 Cushioning material
24 Insulation material
25 Shield material
30 Opening
31 Cooling unit
33 Cooling block
34 Pipe
35 Flow path
41 Window material
L Laser

1. A laser processing apparatus comprising:
an electro-optical element;
a laser irradiation unit that irradiates the electro-optical element with laser;
a pair of electrodes provided on both sides of the electro-optical element so as to sandwich the electro-optical element therebetween;
a cushioning material having conductivity provided between the pair of electrodes and the electro-optical element;
a shield material that is provided on an incident side of the electro-optical element, in an irradiation direction of the laser intersecting a direction in which a voltage applied by the pair of electrodes is applied, and prevents incidence of the laser onto the cushioning material; and
a cooling unit that cools the shield material, wherein
the cooling unit includes a cooling block and a pipe connected to the cooling block,
the cooling block is provided at a portion located on one electrode side of the shield material, and is provided so as to extend in the width direction,
the cooling block is formed of metal, and a flow path through which cooling water flows is formed inside the cooling block, and
the pipe is connected to the flow path of the cooling block to circulate the cooling water.

2. The laser processing apparatus according to claim 1, wherein the electro-optical element is a KTN crystal.

3. The laser processing apparatus according to claim 1, wherein the shield material is formed in a plate shape and has an opening through which the laser passes.

4. The laser processing apparatus according to claim 3, wherein
in an orthogonal plane orthogonal to the irradiation direction of the laser, when a direction in which the pair of electrodes face each other is defined as a height direction, and a direction orthogonal to the height direction is defined as a width direction,
in the shield material,
a length of the opening in the height direction is larger than a beam diameter of the laser, and smaller than the length of the electro-optical element in a height direction, and
a length between the opening and the cushioning material is 0.1 mm or more or 10% or more of the beam diameter, whichever is smaller.

5. The laser processing apparatus according to claim 4, wherein a length of the opening in the width direction is larger than the beam diameter of the laser and equal to or less than a length of the electro-optical element in the width direction.

6. The laser processing apparatus according to claim 1, wherein
the shield material is metal, and
the laser processing apparatus further comprises an insulating portion provided between the shield material and the electrode.

7. The laser processing apparatus according to claim 1, wherein the laser incident on the electro-optical element is a collimated laser.

8. (canceled)

9. The laser processing apparatus according to claim 1, further comprising:
a window material that is provided on the incident side of the electro-optical element, in the irradiation direction of the laser, and covers the electro-optical element.

10. The laser processing apparatus according to claim 9, wherein the window material is provided between the electro-optical element and the shield material.

11. The laser processing apparatus according to claim 10, wherein
the shield material is metal, and
the window material functions as an insulation material provided between the shield material and the electrode.

12. (canceled)
